(19) United States
(12) Patent Application Publication
(10) Pub. No.: US 2007/0151945 A1
(43) Pub. Date: Jul. 5, 2007

(54) METHOD OF ERASING IMAGE AND METHOD OF RECYCLING RECORDING MEDIUM

(75) Inventors: Naotoshi Miyamachi, Tokyo (JP); Shunichiro Nishida, Tokyo (JP); Yasuhiro Naito, Kawasaki-shi (JP); Toshiya Yuasa, Kawasaki-shi (JP); Tatsunori Ishiyama, Yokohama-shi (JP); Yuichi Hashimoto, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/688,443

(22) Filed: Mar. 20, 2007

Related U.S. Application Data
(63) Continuation of application No. PCT/JP06/20037, filed on Sep. 29, 2006.

(30) Foreign Application Priority Data
Sep. 30, 2005 (JP) 2005-288842

(51) Int. Cl. B44C 1/22; C03C 25/68

(52) U.S. Cl. 216/58

(57) ABSTRACT

Provided is a method of erasing an image, including exposing an image, formed by applying ink containing a dye to a recording medium, to an oxidizing gas generated by discharge to erase the image, wherein the dye comprises an anionic anthraquinone dye and a method of recycling a recording medium.

This application is a continuation of International Application No. PCT/JP2006/320037, filed Sep. 29, 2006, which claims the benefit of Japanese Patent Application No. 2005-288842, filed Sep. 30, 2005.

### BACKGROUND OF THE INVENTION

1. Field of the Invention

The present invention relates to a method of erasing an image formed on a recording medium and a method of recycling a recording medium.

2. Description of the Related Art

Along with the spread of computers, printers, copying machines, facsimiles etc., requirement for output on paper is increasing more and more. No other media have ever become comparable to paper in visibility and portability, and although realizing electronic information society or paperless society has shown progress, the demand for paper is still increasing.

On the other hand, in order to effectively utilize limited resources, technical development for recycling and reuse of paper is becoming increasingly important. In a prior paper recycling method, a recovered paper is repulped with water, then subjected to floating removal of an ink portion by a deinking process, further bleached and used as “recycled paper”. However the method has drawbacks that the paper strength is lowered and that a process cost is higher in comparison with a case of manufacturing new paper. Consequently, there is desired a method capable of reusing or recycling paper without a deinking process.

Based on the background, investigations are being made for a method of printing paper with an image forming material including an erasable dye composition capable of changing a color-forming compound in a colored state to an erased state. Reported examples of a decoloring method involving the use of such image forming material include a method involving the utilization of a reversible change in transparency of a recording layer based on the control of heat energy to be applied (see Japanese Patent Application Laid-Open No. S63-39377) and a method involving the utilization of an intermolecular interaction between a color coupler having electron-donating property and a developer having electron-accepting property (see Japanese Patent Application Laid-Open No. 2001-105741). There have been also reported an ink containing a dye which is decolored by irradiation with an electron beam (see Japanese Patent Application Laid-Open No. H11-116864) and an ink containing an additive having an action of decoloring a colorant by irradiation with light (see Japanese Patent Application Laid-Open No. 2001-49157). Further, there have been reported an ink-jet ink using an Monascus dye so that the ink can be decolored by irradiation with light, and a recording method using the ink (see International Patent Application No. WO02/088265). In addition, a method of decomposing and erasing an image on plain paper by using an activated gas has been proposed (see Japanese Patent Application Laid-Open No. H07-253736).

### SUMMARY OF THE INVENTION

However the methods described in Japanese Patent Application Laid-Open Nos. S63-39377 and 2001-105741 are impractical since the recording medium, writing-erasing apparatus etc. are expensive in the initial cost and in the running cost. Also, the method described in Japanese Patent Application Laid-Open No. H11-116864, employing electron beam irradiation, may cause the deterioration of a base material or generation of a secondary X-ray, even though slightly. Also in the ink described in Japanese Patent Application Laid-Open No. 2001-49157, the additive to be employed is more specifically a dye-based sensitizer and is employed in a large amount of 1/10 to 10/10 in weight ratio with respect to the coloring material, thus resulting a high cost of the ink. Also, there is a demand for a method capable of erasing an image easier and faster compared to the methods described in International Patent Application No. WO02/088265 pamphlet and Japanese Patent Application Laid-Open No. H07-253736.

Therefore, an object of the present invention is to provide a method with which an image (including a letter) formed on a recording medium typified by paper is easily and quickly erased without any reduction in mechanical strength of the recording medium so that the used recording medium can be recycled at a low cost and the reuse of resources can be achieved.

Another object of the present invention is to provide an apparatus for performing the method.

In view of the above objects, the inventors of the present invention have made extensive studies on a dye when a printed article obtained by forming an image (including a letter, the same holds true for the following) on a recording medium by using ink-jet ink is exposed to an oxidizing gas so that the image is erased. As a result, the inventors of the present invention have found that an image formed of ink containing an anionic anthraquinone dye can be easily and quickly erased at a low cost, thereby completing the present invention.

The term “erasing of an image” as used herein refers to a state where the optical density of an image formed on a recording medium is reduced by an erasing treatment to such an extent that the resultant can be recycled as a recording medium. Such state includes not only the case where the image formed on the recording medium cannot be visually recognized at all (hereinafter abbreviated as “decoloring”) but also the case where an optical density is reduced to 80% or less of the optical density of an initial image formed on the recording medium (hereinafter abbreviated as “color reduction”). The color reduction represented in terms of a residual optical density rate corresponds to the case where an optical reflectance is reduced to 20% or less of an initial optical reflectance at the maximum absorption wavelength of a colored portion.

The present invention provides a method of erasing an image, including exposing an image formed by applying ink containing a dye to a recording medium to an oxidizing gas generated by discharge to erase the image, in which the dye includes an anionic anthraquinone dye.

Further the present invention provides a method of recycling a recording image including the step of erasing an image by the above-mentioned method of erasing an image.

According to the present invention, a deinking step can be dispersed with, the need for incorporating a unit for deinking into an erasing apparatus can be eliminated, and, furthermore, a simple constitution for an erasing apparatus can be employed so that the size of the apparatus can be reduced. Therefore, according to the present invention, there can be provided a method of easily and quickly erasing an image at low cost.

Further features of the present invention will become apparent from the following description of exemplary embodiments with reference to the attached drawings.

### BRIEF DESCRIPTION OF THE DRAWINGS

FIG. 1 is a schematic lateral view showing an example of an erasing apparatus of the present invention.

FIG. 2 is a schematic lateral view showing another example of an erasing apparatus of the present invention.

FIG. 3 is a schematic lateral view showing still another example of an erasing apparatus of the present invention.

FIG. 4 is a schematic lateral view showing still another example of an erasing apparatus of the present invention.

FIG. 5 is a schematic lateral view showing still another example of an erasing apparatus of the present invention.

FIG. 6 is a schematic lateral view showing still another example of an erasing apparatus of the present invention.

FIG. 7 is a schematic lateral view showing still another example of an erasing apparatus of the present invention.

FIG. 8 is a schematic lateral view showing still another example of an erasing apparatus of the present invention.

FIG. 9 is a schematic lateral view showing still another example of an erasing apparatus of the present invention.

FIG. 10 is a schematic lateral view showing still another example of an erasing apparatus of the present invention.

FIG. 11 is a schematic lateral view showing still another example of an erasing apparatus of the present invention.

### DETAILED DESCRIPTION OF THE PREFERRED EMBODIMENTS

Hereinafter, an embodiment of the present invention in employing an ink-jet recording method will be described in more detail.

[1] Color Material

(1) Dye

Preferable examples of the anionic anthraquinone dye to be used in the present invention include the following.

That is, there can be used Acid Black 48, Acid Black 97, Acid Blue 8, Acid Blue 13, Acid Blue 25, Acid Blue 27, Acid Blue 35, Acid Blue 40, Acid Blue 41, Acid Blue 43, Acid Blue 45, Acid Blue 47, Acid Blue 49, Acid Blue 51, Acid Blue 53, Acid Blue 55, Acid Blue 56, Acid Blue 62, Acid Blue 68, Acid Blue 69, Acid Blue 78, Acid Blue 80, Acid Blue 81, Acid Blue 96, Acid Blue 111, Acid Blue 112, Acid Blue 124, Acid Blue 127, Acid Blue 129, Acid Blue 138, Acid Blue 145, Acid Blue 150, Acid Blue 175, Acid Blue 215, Acid Blue 230, Acid Blue 277, Acid Blue 344, Acid Brown 26, Acid Brown 27, Acid Green 25, Acid Green 27, Acid Green 36, Acid Green 37, Acid Green 38, Acid Green 41, Acid Green 42, Acid Green 44, Acid Violet 34, Acid Violet 36, Acid Violet 42, Acid Violet 43, Acid Violet 51, Acid Violet 63, Mordant Black 13, Mordant Black 57, Mordant Blue 8, Mordant Blue 23, Mordant Blue 24, Mordant Blue 32, Mordant Blue 48, Mordant Blue 50, Mordant Brown 42, Mordant Brown 44, Mordant Orange 14, Mordant Red 2, Mordant Red 3, Mordant Red 4, Mordant Red 11, Mordant Red 45, Mordant Violet 26, Reactive Blue 2, Reactive Blue 4, Reactive Blue 5, Reactive Blue 6, Reactive Blue 19, Reactive Blue 27, Reactive Blue 36, Reactive Blue 49, Reactive Blue 50, Reactive Blue 69, Reactive Blue 74, Reactive Blue 94, Reactive Blue 166, Reactive Blue 246, Reactive Blue 247, Cochineal pigment, Lac pigment, Madder pigment, and the like.

Of those, Acid Blue 112 is particularly preferable in view of being easily eliminated and being hardly influenced by conditions of a discharging means and the like.

[2] Ink for Ink Jet

An image in the present invention is formed on the recording medium by an ink jet recording method utilizing an ink jet ink containing the anionic anthraquinone dye as a coloring material. The ink jet ink can be prepared by dissolving and/or dispersing the anionic anthraquinone dye in water or an organic solvent or in a mixture of water and an organic solvent.

It should be noted that, in the present invention, a decoloring ink except the ink containing the anionic anthraquinone dye may be used in combination for the formation of an image; an image is preferably formed only of the ink containing the anionic anthraquinone dye, or mainly of the ink containing the anionic anthraquinone dye.

(1) Solvent

As an organic solvent, known one ordinarily employed in an ink jet ink can be used. Specific examples thereof include an alcohol, a glycol, a glycol ether, a fatty acid ester, a ketone, an ether, a hydrocarbon solvent, and a polar solvent. Water may be added in the case where the organic solvent is water-soluble. In this case, a water content in the ink is preferably within a range of 30 to 95 weight % with respect to the total weight of the ink.

As the organic solvent, an alcohol or a glycol is preferable. Examples of alcohol include methanol, ethanol, 1-propanol, 2-propanol, 1-butanol, 2-butanol, isobutyl alcohol, and t-butyl alcohol.

Examples of glycol may include the following.

That is, the examples are ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol.

Those organic solvent may be employed singly or in a suitable combination of two or more kinds. For example, there can be employed a combination of an alcohol and/or a glycol and a polar solvent.

Examples of the polar solvent may include the following.

That is, the examples are 2-pyrrolidone, formamide, N,N-dimethylformamide, N,N-dimethylacetamide, dimethyl sulfoxide, sulforan, N-methyl-2-pyrrolidone, N-vinyl-2-pyrrolidone, 2-oxazolidone, 1,3-dimethyl-2-imidazolidinone, acetonitrile, and acetone.

The dye as the coloring material may be dissolved in water or in an organic solvent, or may be pulverized with various dispersing equipment if necessary and dispersed with a suitable dispersant (surfactant). Examples of the dispersing equipment include a ball mill, a sand mill, an attritor, a roll mill, an agitator mill, a Henschel mixer, a colloid mill, an ultrasonic homogenizer, a pearl mill, a jet mill, and an ong mill. The surfactant can be any one of cationic, anionic, amphoteric, and nonionic.

The ink jet ink may further contain, if necessary, a binder, a pH regulating agent, a viscosity regulating agent, a penetrating agent, a surface tension regulating agent, an antioxidant, an antiseptic, an antimold agent, or the like.

The content of the dye is preferably 0.01 to 90 mass % with respect to the entire weight of the decolorable ink (composition), and more preferably 0.5 to 15 mass %. In this manner, there can be obtained satisfactory printing property.

Although a method for using ink jet recording has been described above, a printing on the recording medium with the ink can also be performed by a method utilizing a writing utensil of a pen shape or the like other than the ink jet printing method.

[3] Image Erasing Method and Apparatus

A method of erasing an image containing an anionic anthraquinone dye (which may hereinafter be simply referred to as “image”) according to the present invention includes the step of exposing a recording medium on which the image has been formed to an oxidizing gas.

The oxidizing gas is preferably an ionized/dissociated gas or a secondary product thereof. The secondary product is preferably at least one selected from the group consisting of ozone, a hydroxy radical, a carbonate ion, and a nitrogen oxide.

The oxidizing gas is generated by creeping discharge or corona discharge, or a discharging means of a dielectric barrier discharge.

In the following, each oxidizing-gas generating means according to the present invention will be explained in detail, with reference to accompanying drawings. A gas capable of generating an oxidizing gas through discharge can be, for example, air, oxygen, nitrogen, carbon dioxide, or water vapor. If necessary, two or more kinds of those gases may be used in combination.

In the following there will be explained a case of employing air as an example.

(1) Creeping Discharge

In case of creeping discharge, discharge is generated along a dielectric member by applying an AC voltage between a pair of electrodes separated by the dielectric member, thereby generating an oxidizing gas. An image decoloring/color-substrating method in this case is preferably executed by placing a printed article or causing the printed article to run in or in the vicinity of a discharge area of the creeping discharge. Also for causing the printed article to run, it is preferable to employ at least one conveying means selected from the group consisting of an endless belt conveying, a roll conveying, and a drum conveying. The run may be run in a certain direction, reciprocating run, or a combination of them.

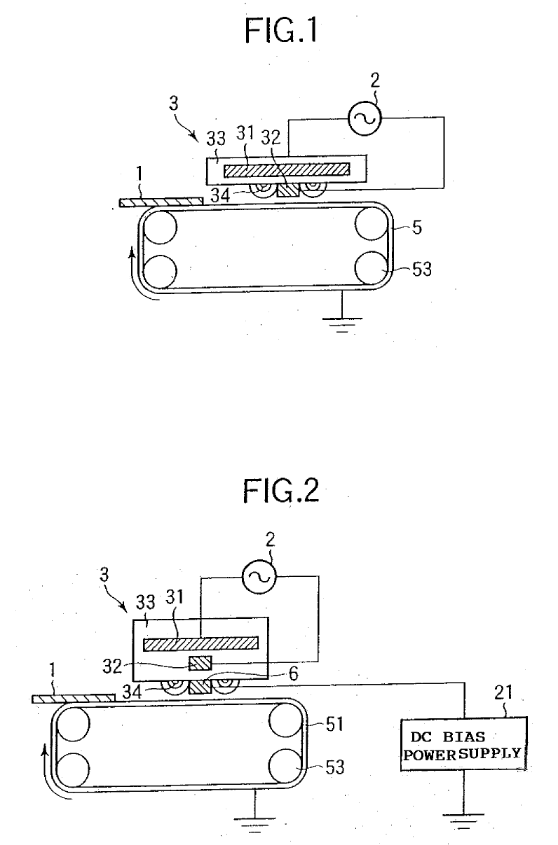

FIG. 1 is a schematic lateral view showing an example of an apparatus of the present invention for erasing an image of a printed article, for example obtained by forming an image on a recording medium by an ink jet recording (hereinafter, the printed article will simply be called a “printed article” unless specified otherwise). FIG. 1 shows an example of generating an oxidizing gas by applying an AC voltage to creeping discharge electrodes.

The oxidizing gas generated by creeping discharge in the air is an ionized/dissociated gas or a secondary product thereof, for example, ozone, a carbonate ion, a nitrogen oxide, or the like. A similar oxidizing gas is generated also with corona discharge to be explained later, but the creeping discharge further improves an efficiency of generation of the oxidizing gas.

Referring to FIG. 1, an electrode 3 for the creeping discharge includes a pair of electrodes 31 and 32 mutually opposed and separated by a dielectric member 33. As shown in FIG. 1, an electrode 31 is embedded in the dielectric member 33, and the other electrode 32 is provided at a bottom surface of the dielectric member 33. The oxidizing gas is generated in a discharge area 34, present in a vicinity of the electrode 32 provided under the bottom surface of the dielectric member 33. In FIG. 1, there is also shown an AC power supply 2.

The electrodes 31 and 32 are not particularly restricted in shapes thereof, and it is possible, for example, to form an electrode 31 embedded in the dielectric member 33 in a plate shape and to form the electrode 32 under the bottom surface of the dielectric member 33 in a wire shape. Each of the electrodes 31 and 32 may be constituted of a metal such as Al, Cr, Au, Ni, Ti, W, Te, Mo, Fe, Co, or Pt, or an alloy or an oxide thereof. The electrodes 31 and 32 preferably have a mutual distance of 1 μm or larger, and more preferably 3 to 200 μm. An AC voltage (Vpp) applied to the creeping discharge electrode 3 is preferably within a range of 1 to 20 kV, and preferably has a frequency of 100 Hz to 5 MHz, and it is particularly preferable to employ a Vpp of 1 to 10 kV with a frequency of 1 kHz to 2 MHz because the image erasure can be executed more efficiently. In this case, it is preferred to select a distance between the electrode 32 and the printed article to be 100 mm or less (including a distance of 0 mm corresponding to a case where the printed article and the electrode are in a mutual contact).

The dielectric member 33 is formed of a material that can form a surface capable of generating creeping discharge. Examples of the material include ceramics and glass. Specific example of the ceramics and the glass constituting the dielectric member 33 include a metal oxide such as silica, magnesia or alumina, and a nitride such as silicon nitride or aluminum nitride.

In exposing Printed Article 1 to the oxidizing gas, whether Printed Article 1 is maintained stationarily or moved relatively to the discharge area 34 may be selected according to the purpose. FIG. 1 shows an example in which Printed Article 1 is conveyed by a conductive endless belt 5 rotated by a roll 53 in the vicinity of creeping discharge area 34. The conductive endless belt 5 is so positioned as to pass a vicinity or an interior of the discharge area 34, whereby the discharge area 34 spreads in a space between the conductive endless belt 5 and itself to improve a contact efficiency between Printed Article 1 and the oxidizing gas. For this purpose, it is preferable to ground the conductive endless belt 5 as shown in FIG. 1 or to apply a positive or negative voltage thereto. A conveying speed may be set depending on Vpp, a frequency, and a distance between the electrode 32 and Printed Article 1, but is preferably 2,000 cm/min or less for the aforementioned ranges of the Vpp, frequency, and distance, and particularly preferably 500 cm/min or less, so that the image erasure can be executed more efficiently.

Conveying means for conveying Printed Article 1 is not particularly limited and can be constituted by known means. In addition to the conveying by an endless belt, there can also be employed, for example, a roll conveying or a drum conveying. The conveying means is preferably constituted of a conductive material as described above, but this is not restrictive and it may also be constituted of a non-conductive material. A conductive material constituting the conveying means can be the same as those described for the electrodes 31 and 32.

The exposure of Printed Article 1 to the oxidizing gas may be executed either in a closed system or in an open system, which may be selected according to the purpose. However, it is executed preferably in a closed system in order that the oxidizing gas does not leak out from the color-substrating/decoloring apparatus. The color-substrating/decoloring apparatus is preferably provided with an adsorption filter for preventing leakage of the oxidizing gas.

FIG. 2 is a schematic lateral view showing another embodiment of the apparatus for erasing an image through creeping discharge. Components or parts equivalent to those in FIG. 1 are represented by the same reference numerals. An electrode 3 for creeping discharge shown in FIG. 2 is an application of a configuration of a charging/charge-eliminating apparatus described in Japanese Patent Application Laid-Open No. S62-177882 to the apparatus for performing the method of the present invention, and is an example in which a pair of mutually opposed electrodes 31 and 32 are embedded in a dielectric member 33. In this case, the oxidizing gas is generated in a portion (a portion indicated as a discharge area 34 shown in FIG. 2) corresponding to an end portion of the electrode 32 at a bottom surface of the dielectric member 33.

In the example shown in FIG. 2, as described in Japanese Patent Application Laid-Open No. S62-177882, a first bias electrode 6 and a power supply 21 for supplying the first bias electrode 6 with a DC bias voltage are provided on the bottom surface of the dielectric member 33. An application of the bias voltage between the first bias electrode 6 and a conductive endless belt 51 serving also as a second bias electrode causes the oxidizing gas to move from a generating position toward Printed Article 1, thereby improving the contact efficiency between Printed Article 1 and the oxidizing gas. The bias voltage is preferably in the range of 0.2 to 4.0 kV. The first bias electrode 6 can be constituted of the same material as that for the electrodes 31 and 32.

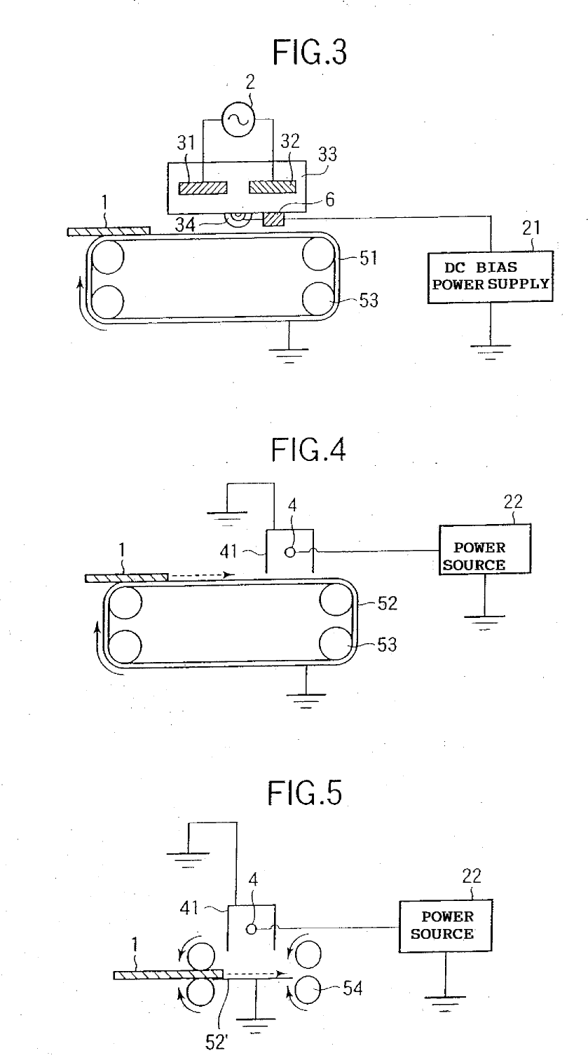

FIG. 3 is a schematic lateral view showing another embodiment of the apparatus for erasing an image by creeping discharge. The same members or parts as those of the apparatus shown in FIG. 2 are represented by the same reference numerals. Creeping discharge electrode shown in FIG. 3 is also an application of the configuration of the charging/charge-eliminating apparatus described in Japanese Patent Application Laid-Open No. S62-177882 to the color-substrating/decoloring apparatus for carrying out the method of the present invention, and is an example in which a pair of electrodes 31 and 32 are embedded so as to be arranged in a plane parallel to a bottom surface of a dielectric member 33. In this case, the oxidizing gas is generated principally in the vicinity (a portion indicated as a discharge area 34 shown in FIG. 3) between electrodes 31 and 32 on the bottom surface of the electric member. If necessary, there may also be adopted a configuration, in which, as described in Japanese Patent Application Laid-Open No. S62-177882, three electrodes are embedded so as to be arranged on a plane parallel to the bottom surface of the dielectric member 33 (not shown).

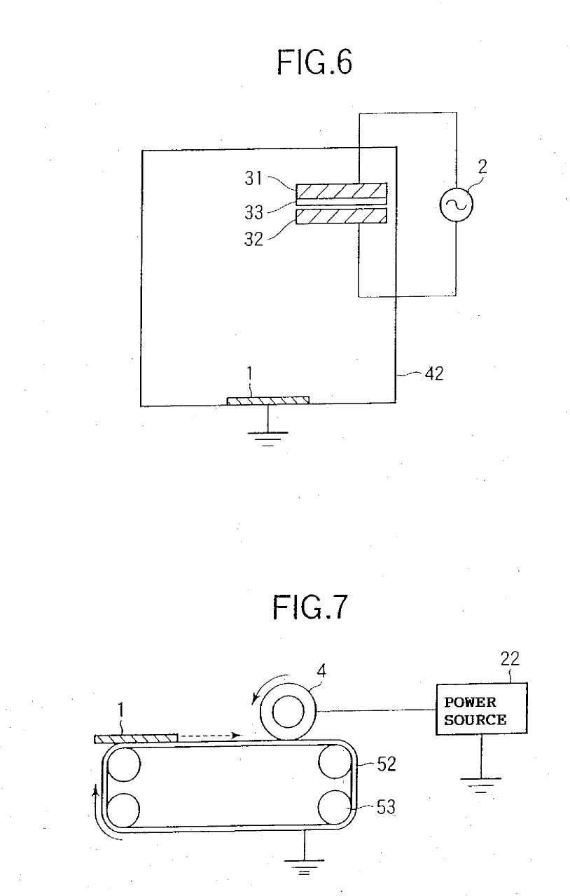

FIG. 6 is a schematic lateral view showing another embodiment of the apparatus for erasing an image by creeping discharge. The same members or parts as those of the apparatus shown in FIG. 1 are represented by the same reference numerals. A dielectric layer 33 is provided on the electrodes 31 and/or 32. In the example shown in FIG. 6, both electrodes 31 and 32 are formed in a plate shape, and the dielectric member 33 is formed on the electrode 31. Printed Article 1 is not positioned between the electrode 31 and the counter electrode 32, but is placed stationarily in a closed container 42 covering the electrode 31, the dielectric member 33 and the plate-shaped counter electrode 32. The dielectric member 33 may be constituted of a material described for the case shown in FIG. 1 for utilizing the creeping discharge.

(2) Corona Discharge

In case of corona discharge, a voltage is applied between a discharge electrode and a counter electrode opposed to the discharge electrode to generate a discharge, thereby generating an oxidizing gas. The voltage applied to the discharge electrode can be an AC voltage or a DC voltage. In case of applying a DC voltage to the discharge electrode, a negative polarity is preferable. It is also possible to superpose an AC voltage with a DC voltage to be applied to the discharge electrode. The discharge is preferably generated in a state where the counter electrode is grounded. The discharge electrode can have a wire shape, a roll shape, a blade shape, a plate shape, a brush shape, a needle shape, or a bar shape. It is also preferable to bring the counter electrode into a contact with at least a part of the printed article. In the color-substrating/decoloring method for an image in this case, it is preferable to cause the printed article to remain stationary or to run in a discharge space between the discharge electrode and the counter electrode. In order to cause the printed article to run, there is also preferably employed at least one conveying means selected from the group consisting of endless belt conveying, roll conveying, and drum conveying. It is further preferable that the conveying means have conductivity, thereby serving also as the counter electrode. The run may be run in a certain direction, reciprocating run, or a combination of them.

FIG. 4 is a schematic lateral view showing an example of an apparatus for erasing, by corona discharge, an image of a printed article in which an image (including a character) is formed on a recording medium by, for example, an ink jet recording. The same members or parts as that of the apparatus shown in FIG. 1 are represented by the same reference numerals. In general, corona discharge is generated by providing a discharge electrode and a counter electrode in a position opposed thereto and applying a voltage to the discharge electrode. In the apparatus shown in FIG. 4, the discharge electrode 4 is formed in a wire shape, and a conductive endless belt 52 functions as a counter electrode. In order to efficiently generate an ionized/dissociated gas and a secondary product thereof by corona discharge, it is preferable, as shown in FIG. 4, to ground the conductive endless belt 52. In FIG. 4, reference numeral 22 and 41 denote a DC voltage applying means and a cover for covering the discharge electrode 4, respectively.

The applied voltage can be a DC voltage or a DC voltage superposed with an AC voltage. A particularly satisfactory image erasure can be achieved in case of applying a DC voltage of a negative polarity to the discharge electrode 4. In particular, the application of a DC voltage of a negative polarity to the discharge electrode 4 causes an efficient generation of an ionized/dissociated gas composed of oxidizing gas and a secondary product thereof. The gas composition composed of those ionized/dissociated gas and a secondary product thereof is considered to be particularly effective for reducing the color forming property of a dye contained in an ink.

A material constituting the discharge electrode 4 and the counter electrode 52, which is suited for a shape or a structure of the electrodes, can be selected from those described for the creeping discharge electrodes 31 and 32 in the foregoing item (1). The electrodes shown in configurations shown in FIGS. 5 and 7 to 9 are also similarly constructed.

The corona discharge is initiated by an application of a voltage equal to or higher than a predetermined threshold voltage (discharge starting voltage). In the present invention, a DC voltage applied to the discharge electrode is preferably in the range of −0.5 to −20.0 kV, and more particularly −0.5 to −10.0 kV. Under the DC voltage, a distance between the discharge electrode and the printed article is preferably set to be 30 mm or less (including 0 mm in the case where those are in mutual contact). In this manner, it is possible to further efficiently erase the image of the printed article.

The shape of the discharge electrode 4 is not particularly limited, and can have a known shape such as, in addition to a wire shape, a roll shape, a blade shape, a plate shape, a brush shape, a needle shape, or bar shape. Particularly, when the corona discharge is performed, a corona charger employing a wire shaped conductive material as the discharge electrode allows to obtain a uniform and high color-substrating/decoloring property to a dye over a wide area.

Printed Article 1 is preferably in contact with the counter electrode 52, but is not necessarily be in contact. When Printed Article 1 is made present in a discharge area (area principally between the discharge electrode 4 and the counter electrode 52), Printed Article 1 can be made stationary or made to run with respect to the discharge area depending on the purpose. In case of an exposure to the oxidizing gas under a movement of the printed article, a moving speed of the printed article differs depending on a concentration of the oxidizing gas and a distance between the discharge electrode and the printed article. For example, it is preferably 2,000 cm/min or less for the aforementioned voltage and distance, and particularly preferably 500 cm/min or less, so that the image erasure can be executed more efficiently.

As already explained on the creeping discharge in the foregoing item (1), an exposure of Printed Article 1 to the oxidizing gas may be executed in a closed system or an open system, according to the purpose, but it is executed preferably in a closed system. In case of a closed system, Printed Article 1 may be placed stationarily outside the discharge area (area principally between the discharge electrode 4 and the counter electrode 52).

FIG. 5 is a schematic lateral view showing another example of the apparatus for erasing, by corona discharge, an image on a recording medium. The same members or parts as those of the apparatus shown in FIG. 4 are represented by the same reference numerals. In the example shown in FIG. 5, Printed Article 1 is conveyed on a conductive plate 52′ by a conveyor having a roller 54.

FIG. 7 is a schematic lateral view showing another example of the apparatus for erasing, by corona discharge, an image on a recording medium. The same members or parts as those of the apparatus shown in FIG. 4 are represented by the same reference numerals. FIG. 7 shows an example provided with a roll-shaped discharge electrode 4. The roll-shaped discharge electrode 4 is in contact with a conductive endless belt 52 and is applied with a voltage while being rotated by the rotation of the conductive endless belt 52. Printed Article 1 passes through the discharge area in contact with both the roll-shaped discharge electrode 4 and the conductive endless belt 52, thus improving the contact efficiency with the oxidizing gas.

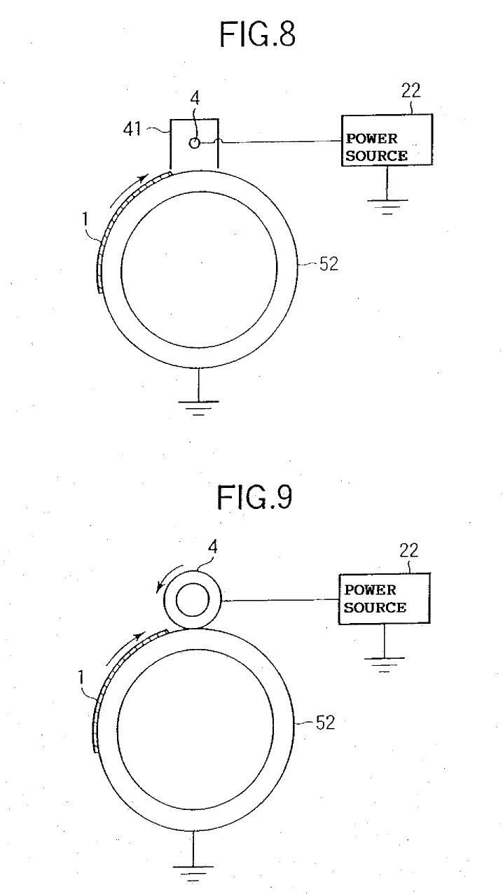

FIG. 8 is a schematic lateral view showing another example of the apparatus for erasing, by corona discharge, an image on a recording medium. The same members or parts as that of the apparatus shown in FIG. 4 are represented by the same reference numerals. FIG. 8 shows an example of employing a conductive drum 52 as conveying means.

FIG. 9 is a schematic lateral view showing another example of the apparatus for color-subtracting or decoloring, by corona discharge, an image on a recording medium. The same members or parts as those of the apparatus shown in FIG. 4 are represented by the same reference numerals. FIG. 9 shows an example of employing a roll-shaped discharge electrode 4 and a conductive drum 52.

(3) Dielectric Barrier Discharge

Dielectric barrier discharge to be employed in the present invention is a method involving: coating one side or both sides inside electrodes with a dielectric substance; applying a voltage between the electrodes to generate discharge; and producing the plasma of a gas present between the electrodes. According to the method, plasma can be stably generated in the air. In the present invention, the dielectric barrier discharge is applicable to each of a closed system and an open system. Examples of an electrode material for use in the dielectric barrier discharge include: metals such as Sn, In, Al, Cr, Au, Ni, Ti, W, Te, Mo, Fe, Co, and Pt, and alloys of the metals; oxides such as ITO and ZnO; and a polymer sheet or rubber belt in which conductive particles are dispersed. An electrode shape may be a plate shape, a mesh shape, a belt shape, a drum shape, or a linear shape. Both the electrodes may have different shapes.

Examples of a usable dielectric material with which an electrode is coated include a carbon compound, ceramics, glass, a ferroelectric material, and a polymer discharge material. Specific examples of the dielectric material include the following.

Examples of the dielectric material include: diamond, diamond-like carbon, and metal oxides such as silica, magnesia, alumina, and zirconia; nitrides such as silicon nitride and aluminum nitride; magnesium titanate; barium titanate; lead zirconate titanate; polyethylene; vinyl chloride; polyethylene terephthalate; acryl; polycarbonate; and polyvinylidene floride. A dielectric substance can be used by: sticking any of those sheet-like materials to an electrode; forming an electrode under vacuum on a surface of the dielectric substance by an ion plating method; or preparing a complex in which those materials are dispersed in a binder.

Examples of a gas that produces plasma by the dielectric barrier discharge include air, oxygen, nitrogen, carbon dioxide, and water vapor. Specific examples of plasma (ionization/dissociation gas) or a secondary product of the plasma include ozone, a hydroxyl radical, a carbonate ion, and an oxidizing gas of a nitrogen oxide.

The dielectric barrier discharge to be employed in the present invention is preferably discharge involving the application of a voltage between a first electrode coated with a dielectric substance and a second electrode separated from the first electrode. The voltage to be applied between the first electrode and the second electrode is preferably an alternating voltage having a voltage amplitude Vpp of 1 to 40 kV and a frequency of 10 Hz to 20 kHz. Further, the application of an alternating voltage having a voltage amplitude Vpp of 1 to 30 kV and a frequency of 20 Hz to 10 kHz enables an image to be erased with improved efficiency. The wave form of the alternating voltage to be applied may be a sinusoidal wave form, a triangular wave form, a square wave form, or a pulse wave form, or may be a combination of two or more of those wave forms.

Upon exposure of ink fixed on a recording medium to an oxidizing gas generated by the dielectric barrier discharge, the recording medium is preferably placed in or near a discharge region because an image can be efficiently erased. In this case, it is preferable that: the dielectric substance with which the first electrode is coated and the surface on which the ink is fixed be placed in parallel to be opposed to each other; and a distance between the dielectric substance and the recording medium be larger than 0 and 100 mm or less. The distance is more preferably 0.5 mm or more. In addition, an image can be efficiently erased when an electrode surface coated with the dielectric substance has an area equal to or larger than that of the recording medium.

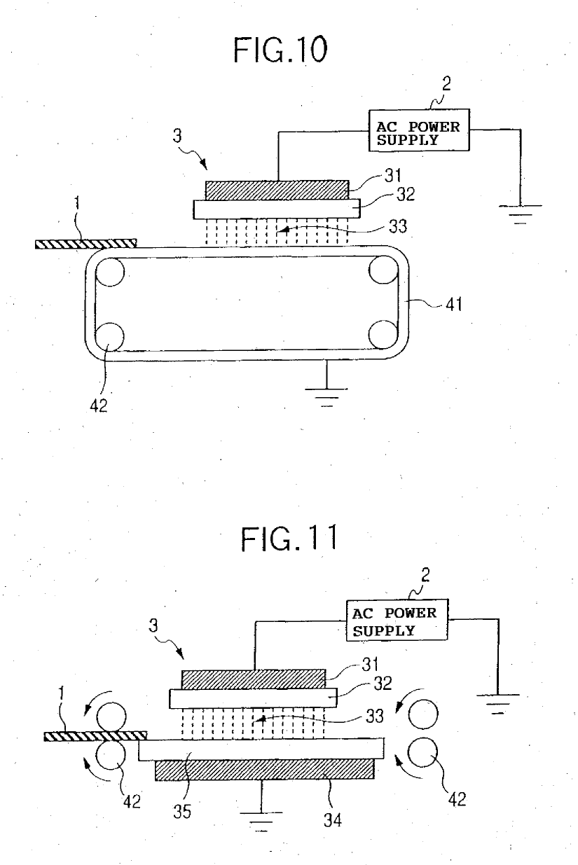

FIG. 10 is a schematic side view showing an example of an image erasing apparatus of the present invention. As shown in FIG. 10, barrier discharge electrodes 3 including a first electrode 31 and a second electrode 41 which are separated by a dielectric substance 32 and which are provided to be opposed to each other are provided. The dielectric substance 32 is provided to be in close contact with the first electrode 31. The second electrode 41 is a conductive endless belt that moves in an endless manner owing to the rotation of rolls 42, and functions as a portion for supporting a recording medium 1 and as means for conveying the medium. The first electrode 31 is connected to a reference potential point via an AC power supply 2. When a voltage is applied from the AC power supply 2, an oxidizing gas is generated in a discharge region 33 between the second electrode 41 connected to a reference potential point and the dielectric substance 32. Since the second electrode 41 is of a belt shape, the discharge region 33 is expanded, the oxidizing gas can be generated over a wide range, and the recording medium can be efficiently exposed to the oxidizing gas. A positive or negative direct voltage can be applied to the second electrode 41.

The alternating voltage to be applied to the barrier discharge electrodes 3 preferably has an amplitude Vpp in the range of 1 to 40 kV and a frequency in the range of 10 Hz to 20 kHz. Setting the amplitude and the frequency in those ranges enables the oxidizing gas to be generated with improved efficiency. The amplitude Vpp is more preferably in the range of 1 to 30 kV, and the frequency is more preferably in the range of 20 Hz to 10 kHz. The wave form of the alternating voltage to be applied may be a sinusoidal wave form, a triangular wave form, a square wave form, or a pulse wave form, or may be a combination of two or more of those wave forms. In this case, a distance between the dielectric substance 32 and the recording medium 1 is 100 mm or less, and exceeds 0 mm. The first electrode 31, the second electrode 41, and the dielectric substance 32 are made of the above materials.

The recording medium 1 can be exposed to the oxidizing gas while the recording medium is moved with respect to the discharge region 33, or while the rotation of the rolls 42 is stopped so that the recording medium is stationary. The rate at which the recording medium is conveyed can be selected depending on the amplitude Vpp and frequency of the voltage to be applied to the electrodes, and the distance between the dielectric substance and the recording medium. When the amplitude Vpp and frequency of the voltage, and the distance between the dielectric substance and the recording medium are within the above ranges, a rate at which the recording medium is conveyed of 2,000 cm/min or less, or, if additionally limited, of 600 cm/min or less enables an image to be erased with improved efficiency.

Whether the recording medium 1 is exposed to the oxidizing gas in a closed system or an open system can be selected depending on a purpose; provided that, when the exposure is performed in a closed system so that the oxidizing gas does not leak from the apparatus, it is sufficient to provide an adsorption filter for preventing the oxidizing gas from leaking.

FIG. 11 is a schematic side view showing another example of the image erasing apparatus of the present invention. As shown in FIG. 11 (The same members or parts as those of the apparatus shown in FIG. 10 are represented by the same reference numerals as those shown in FIG. 10), the barrier discharge electrodes 3 including the first electrode 31 coated with the dielectric substance 32 and a second electrode 34 coated with a dielectric substance 35 serving also as a portion for supporting the recording medium 1 are provided. An alternating voltage is applied between the first electrode 31 connected to the AC power supply 2 connected to a reference potential point and the second electrode 34 connected to a reference potential point. Then, when the recording medium 1 is conveyed by the rotation of the pair of rolls 42 onto the dielectric substance 35 in the discharge region 33 formed between the dielectric substance 32 and the dielectric substance 35, the recording medium 1 is exposed to plasma generated in the discharge region 33, whereby an image is made colorless. The above materials can be used in the first electrode 31, the second electrode 34, and the dielectric substances 32 and 35.

In the present invention, the recording medium may be exposed to an oxidizing gas generated by discharge while the recording medium is left standing; the exposure can be performed while the recording medium is caused to travel in or near the discharge region. Any known conveying means can be used as means for causing the recording medium to travel. For example, the recording medium can be conveyed by using an endless belt, a roll, or a drum. The means for conveying the recording medium, which does not need to be conductive, may be conductive to function as the second electrode. The rate at which the recording medium is conveyed can be selected depending on a distance between the recording medium and a dielectric substance, and the magnitude of an applied voltage. The recording medium is conveyed at a rate of preferably 2,000 cm/min or less, or more preferably 600 cm/min or less relative to the first electrode coated with the dielectric substance. The rate within the range enables an image to be erased with improved efficiency and improved sufficiency. When the recording medium is left standing or conveyed in a state of being floated between the dielectric substance with which the first electrode is coated and the second electrode, the ink on both surfaces of the recording medium can be made colorless.

Whether a printed article in the present invention is exposed to an oxidizing gas in a closed system or an open system can be selected depending on a purpose. In the present invention, the exposure is preferably performed in a closed system because the oxidizing gas does not leak from the apparatus. It is preferable to provide an adsorption filter for preventing the oxidizing gas from leaking irrespective of whether the exposure is performed in a closed system or an open system.

When a printed article is exposed to an oxidizing gas in a closed system, a discharge device is preferably provided with a feedback mechanism via which an ozone concentration is kept constant. The ozone concentration can be detected as a result of comparison with a comparative gas in the discharge device by employing a UV absorption method. In addition, the ozone concentration in the discharge device is preferably 100 ppm or more for making the printed article colorless. When the ozone concentration is lower than the value, it is preferable to actuate a discharger of the discharge device immediately to generate an oxidizing gas.

In addition, in the present invention, after the printed article has been made colorless, it is preferable to increase a voltage value and a frequency to be applied to the discharge device to heat the discharger so that ozone unnecessary for making the printed article colorless is decomposed. An ambient temperature of 100° C. or higher is preferable for the efficient decomposition of ozone under heat.

The printed article of which image is erased by an action of a reactive gas generated by creeping discharge, corona discharge, and dielectric barrier discharge as in the apparatus shown in FIGS. 1 to 11 can be reused as a recording medium.

[4] Recording Medium

In the erasing of an image according to the present invention, the image is formed on a recording medium. A recording medium having a surface containing an inorganic pigment is preferably used in the present invention. A recording medium obtained by placing a layer containing an inorganic pigment on a base material is particularly preferable.

From an erasability viewpoint, the inorganic pigment to be employed in the present invention is preferably a porous material. Examples of porous inorganic pigments may include the following.

That is, the examples are alumina, silica, silica-alumina, colloidal silica, zeolite, clay, kaolin, talc, calcium carbonate, barium sulfate, aluminum hydroxide, titanium dioxide, zinc oxide, satin white, diatomaceous clay, and acidic white clay. Of those, it is preferable to use alumina or silica, more preferably alumina.

The base material employed in the recording medium is not particularly restricted, and can be any material such as a paper, a film, a photographic paper, a seal, a label, a compact disk, a metal, a glass, various plastic products, and a form for a delivery service, and can also be a composite material thereof. In the case of paper, there can be employed any recyclable paper without restriction, and an acidic paper, a neutral paper, or an alkaline paper may be employed. A base paper is principally constituted of a chemical pulp represented by LBKP or NBKP, and a filler, and papermaking is executed by an ordinary method utilizing an internal sizing agent or a papermaking additive, if necessary. A mechanical pulp or a recycled pulp may be used in combination as the pulp material to be used or may be used principally. A filler can be, for example, calcium carbonate, kaolin, talc, titanium dioxide, or the like. The base paper may further contain a hydrophilic binder, a matting agent, a hardening agent, a surfactant, a polymer latex, a polymer mordanting agent, or the like or be applied with each of those agents. The base paper preferably has a basis weight of 40 to 700 g/m².

A recording medium can be obtained by: preparing an aqueous coating liquid containing an inorganic pigment and an aqueous binder; and coating a base material with the liquid. Examples of the aqueous binder include, but not limited to, water-soluble polymer compounds such as polyvinyl alcohol, casein, a styrene-butadiene rubber, starch, polyacrylamide, polyvinyl pyrrolidone, polyvinyl methyl ether, and polyethylene oxide. It should be noted that one kind of those water-soluble polymers may be used, or two or more kinds of them may be used in combination as required.

The mass ratio of the inorganic pigment and the aqueous binder (inorganic pigment/aqueous binder) is preferably 0.1 to 100, and more preferably 1 to 20. When the mass ratio of the inorganic pigment and the aqueous binder (inorganic pigment/aqueous binder) exceeds 100, there tends to occur falling of powder materials, and in the case where it is less than 0.1, it is difficult to obtain a sufficient decoloring/color-substrating property for the image.

The aqueous coating liquid is applied on the surface of the base paper by, for example, a roller coating, a blade coating, an air knife coating, a gate roll coating, a bar coating, a spray coating, a gravure coating, a curtain coating, or a comma coating. After the coating, drying is executed for example with a hot air drying oven, a heat drum, or the like to obtain a surface layer containing the inorganic pigment. In case of using a heat drum, a dry finishing can be achieved by pressing the surface layer to a heated finishing surface. Also, the surface layer of the applied layer in a moist state before drying may be processed, in order to coagulate the aqueous binder, with an aqueous solution containing a nitrate salt, a sulfate salt, a formate salt, or an acetate salt of zinc, calcium, barium magnesium, or aluminum.

A coating amount in solid is preferably within a range of 0.1 to 50 g/m². In a coating amount less than 0.1 g/m², it is difficult to obtain a sufficient decoloring/color-substrating property for an ink jet print/image. On the other hand, a coating amount exceeding 50 g/m² scarcely provides an improvement in the print quality or in the decoloring/color-substrating property for the image. In the aqueous coating liquid, there may be suitably blended, if necessary, a pigment dispersant, a moisture retaining agent, a viscosifier, a defoaming agent, a releasing agent, a colorant, a water resistant agent, a moisturizing agent, a fluorescent dye, an ultraviolet absorber, or the like.

[5] Time Necessary for Decoloring of an Image

The image containing an anionic anthraquinone dye can fade (color-subtracting) by exposure to an oxidizing gas, and can preferably be erased to a visually unrecognizable level. Specifically, by an exposure of a printed article to the oxidizing gas, the image becomes paler and eventually not observable. The image erasure is significantly influenced by a discharge voltage, but a time necessary for the decoloring is variable depending on a contact efficiency with the oxidizing gas, a composition of the oxidizing gas, a dye type, a dye concentration, a dye composition, a printing material, or the like. A decoloring time can be regulated by suitably selecting those conditions.

Also, the image erasing method of the present invention is applicable not only in a case of erasing an image of a printed article, thereby reusing it as a recording medium, but also in case of utilizing a printed article, after the image erasure, as a raw material for producing a recycled paper.

### EXAMPLES

In the following, the present invention will be described in further details by examples, but the present invention is not limited to the examples.

### Recording Medium Preparation Example 1

Fine alumina powder (trade name: CATALOID AP-3, manufactured by Shokubai Kasei Kogyo Co.) and polyvinyl alcohol (trade name: SMR-10HH, manufactured by Shinetsu Chemical Co.) were mixed in a mass ratio of 90/10, and mixed with water under stirring so as to obtain a solid content concentration of 20 mass %. The mixture was applied on a polyethylene terephthalate film (PET) film so as to obtain a weight of 30 g/m² after drying, and was dried for 10 minutes at 110° C. to obtain a recording medium 1.

### Recording Medium Production Example 2

The following components were loaded into a 2-liter flask equipped with a stirrer, and the whole was stirred at room temperature for 30 minutes to be uniformly mixed. After that, the mixture was heated to 80° C. and stirred for 2 hours. After that, the mixture was cooled, whereby a high-viscosity, transparent liquid (Binder A) was obtained.

| | |
|---|---|
| Polyethylene glycol (having an average molecular | 800 g |
| weight of 2,000) | |
| Hexamethylene diisocyanate | 65 g |
| Dibutyltin dilaurate | 2 g |
| Ethylene glycol dimethyl ether | 900 g |

The resultant liquid showed a viscosity of 30,000 mPa·s at 25° C., and the polymer in the ethylene glycol dimethyl ether solvent had a number average molecular weight of 85,000. Next, Recording Medium 2 was obtained in the same manner as in Production Example 1 except that Binder A obtained through the above operations was used instead of polyvinyl alcohol.

### Recording Medium Preparation Example 3

In a 2-liter flask equipped with an stirrer, 300 g of hydroxyethyl methacrylate, 350 g of water, 350 g of methanol, and 1.5 g of azobisisobutyronitrile were loaded, and the whole was stirred at room temperature for 60 minutes. After stirring, nitrogen gas was blown in to sufficiently replace the interior of the flask, and then the temperature was gradually raised to 65° C. while gradually passing nitrogen gas. Then the mixture was polymerized for 3 hours in this state, and was cooled to obtain a highly viscous transparent liquid (binder B). The obtained liquid showed a viscosity of 1,800 mPa·s at 25° C., and the polymer contained in water/methanol mixed solvent had a number-average molecular weight of 150,000. Then, Recording Medium 3 was obtained in the same manner as in Production Example 1 except that Binder B obtained through the above operations was used instead of polyvinyl alcohol.

### Recording Medium Preparation Example 4

Colloidal silica (trade name: SNOWTEX C, manufactured by Nissan Chemical Co.) and polyvinyl alcohol (trade name: SMR-10HH, manufactured by Shinetsu Chemical Co.) were mixed in a mass ratio of 90/10. The obtained composition was then stirred with water so as to obtain a solid content concentration of 20 mass %. The mixture was applied on a PET film so as to obtain a weight of 30 g/m² after drying, and was dried at 110° C. for 10 minutes, whereby Recording Medium 4 was obtained.

### Ink Preparation Examples 1 to 5

Components shown in the following Table 1 were mixed, dissolved under sufficient stirring, and then filtered through a Fluoropore filter (trade name, manufactured by Sumitomo Denko Co.) having a pore size of 0.45 μm under pressure, whereby Inks 1 to 5 were obtained. Acetylenol EH (manufactured by KAWAKEN FINE CHEM CO LTD) was used. Acid Blue 112, Acid Green 25, Acid Violet 43, Acid Blue 9, and Cochineal dye (manufactured by Kiriya Chemical Co., Ltd.) were used.

TABLE 1

| | Ink 1 | Ink 2 | Ink 3 | Ink 4 | Ink 5 |
|---|---|---|---|---|---|
| Cochineal dye | 2.5 | | | | |
| Acid Blue | | 1.5 | | | |
| 112 | | | | | |
| Acid Green | | | 1.5 | | |
| 25 | | | | | |
| Acid Violet | | | | 1.5 | |
| 43 | | | | | |
| Acid Blue 9 | | | | | 2.5 |
| Glycerin | 7.5 | 7.5 | 7.5 | 7.5 | 7.5 |
| Diethylene | 7.5 | 7.5 | 7.5 | 7.5 | 7.5 |
| glycol | | | | | |
| Acetylenol EH | 1.0 | 1.0 | 1.0 | 1.0 | 1.0 |
| Water | 81.5 | 82.5 | 82.5 | 82.5 | 81.5 |

### Ink Production Example 6

The following materials were loaded into a batch type sand mill (manufactured by IMEX Co., Ltd.), and the whole was filled with glass beads each having a diameter of 1 mm as media. The mixture was dispersed for 3 hours by using styrene-ethyl methacrylate (acid value 350, weight average molecular weight 3,000, aqueous solution having a solid concentration of 20 wt %, neutralizer=potassium hydroxide) as a dispersant while being cooled with water.

| | |
|---|---|
| Aqueous solution of a dispersant | 30 parts by weight |
| (20-wt % aqueous solution): | |
| Pigment Red 177: | 20 parts by weight |
| Glycerin: | 10 parts by weight |
| Water: | 40 parts by weight |

The above dispersion liquid was added with 270 parts of water, 30 parts of glycerin, and 4 parts of Acetylenol EH, and the whole was sufficiently stirred. After that, the mixture was filtered through a filter having a pore size of 1.00 μm under pressure, whereby Ink 6 was obtained.

### Printed Article Preparation Examples 1 to 11

The obtained Inks 1 to 5 were used to conduct solid print with an on-demand type ink jet printer (trade name: “PIXUS iP3100”, manufactured by Canon Corp.) utilizing a heat generating element as a discharging energy source of ink on Recording Media 1 to 4. Printed Articles 1 to 11 were thereby obtained. The contents of the printed articles are shown in Table 2.

TABLE 2

| | Recording | |
|---|---|---|
| | medium | Ink |
| Printed Article 1 | 1 | 1 |
| Printed Article 2 | 2 | 1 |
| Printed Article 3 | 3 | 1 |
| Printed Article 4 | 4 | 1 |
| Printed Article 5 | 1 | 2 |
| Printed Article 6 | 1 | 3 |
| Printed Article 7 | 1 | 4 |
| Printed Article 8 | 1 | 5 |
| Printed Article 9 | 2 | 5 |
| Printed Article 10 | 3 | 5 |
| Printed Article 11 | 4 | 5 |
| Printed Article 12 | 1 | 6 |

(Evaluation of Decoloring/Color-Substrating Property)

### Examples 1 to 7

In an apparatus shown in FIG. 1 and explained in the foregoing item (3) (1) (dielectric member: alumina ceramics, electrode embedded in the dielectric member: chromium, electrode provided on the bottom surface of the dielectric member: chromium) were used as the erasing apparatus. Under the application of an AC voltage having a frequency of 5 kHz, and an applied voltage Vpp of 4.5 kV to the discharge electrode, printed articles 1 to 7 were conveyed with a speed of 120 mm/min. The creeping discharge electrode 3 and the endless belt 5 were so arranged that the chromium electrode on the bottom surface of the dielectric member and the printed article had a distance of 1.0 mm. The printed articles employed in Examples 1 to 7 correspond to Printed Articles 1 to 7, respectively.

### Example 8

In an apparatus shown in FIG. 5 and explained in the foregoing item (3) (2) (discharge electrode (wire): tungsten, counter electrode (conductive plate): aluminum), under the application of a DC voltage of −1.5 kV to the discharge electrode, Printed Article 1 was conveyed with a speed of 10 mm/min.

### Comparative Examples 1 to 4

In an apparatus shown in FIG. 1 and explained in the foregoing item (3) (1) (dielectric member: alumina ceramics, electrode embedded in the dielectric member: chromium, electrode provided on the bottom surface of the dielectric member: chromium), under the application of an AC voltage having a frequency of 5 kHz and an applied voltage Vpp of 4.5 kV to the discharge electrode, Printed Articles 8, 9, 10, 11, and 12 were conveyed with a speed of 120 mm/min. The creeping discharge electrode 3 and the endless belt 5 were so arranged that the distance between the chromium electrode on the bottom surface of the dielectric member and the printed article became 1.0 mm. The printed articles employed in Comparative Examples 1, 2, 3 and 4 correspond to Printed Articles 8, 9, 10, and 11, respectively.

### Comparative Example 5

Solid printing was performed by an on-demand type ink jet printer (trade name: “PIXUS iP3100”, manufactured by Canon Corp.) utilizing a heat generating element as an ink discharging energy source on a Bright. Recycled paper (manufactured by Fuji Xerox Co.). Ink 2 was used as the ink. Further, the surface of the Bright. Recycled paper does not include an inorganic pigment. Printed Article 12 was obtained in this manner. In an apparatus shown in FIG. 1 and explained in the foregoing item (3) (1) (dielectric member: alumina ceramics, electrode embedded in the dielectric member: chromium, electrode provided on the bottom surface of the dielectric member: chromium) were used as the erasing apparatus. Under the application of an AC voltage having a frequency of 5 kHz and an applied voltage Vpp of 4.5 kV to the discharge electrode, the obtained Printed Article 12 was conveyed with a speed of 120 mm/min.

### Comparative Example 6

In an apparatus shown in FIG. 1 and explained in the foregoing item (3) (1) (dielectric member: alumina ceramics, electrode embedded in the dielectric member: chromium, electrode provided on the bottom surface of the dielectric member: chromium). Under the application of an AC voltage having a frequency of 5 kHz an applied voltage Vpp of 4.5 kV to the discharge electrode, Printed Article 12 was conveyed with a speed of 120 mm/min. The creeping discharge electrode 3 and the endless belt 5 were so arranged that the distance between the chromium electrode on the bottom surface of the dielectric member and the printed article became 1.0 mm.

In each printed article subjected to a discharge process in Examples 1 to 4, and Comparative Examples 1 to 6, optical densities of the print before and after the discharge process was measured by a color transmission/reflection densitometer (trade name: X-Rite 310TR, manufactured by X-Rite, Inc.). The optical density after the discharge process relative to the optical density before the discharge process (residual optical density rate=optical density after discharge process/optical density before discharge process×100) was determined based on the obtained measurement value. Results are shown in Table 3.

TABLE 3

| | Residual optical |
|---|---|
| | density rate |
| Example 1 | 7 |
| Example 2 | 10 |
| Example 3 | 8 |
| Example 4 | 10 |
| Example 5 | 3 |
| Example 6 | 8 |
| Example 7 | 10 |
| Example 8 | 9 |
| Comparative | 81 |
| Example 1 | |
| Comparative | 64 |
| Example 2 | |
| Comparative | 70 |
| Example 3 | |
| Comparative | 74 |
| Example 4 | |
| Comparative | 98 |
| Example 5 | |
| Comparative | 65 |
| Example 6 | |

As is apparent from Examples 1 to 8 of Table 3, a residual optical density rate is low when a printed article printed on a coated layer containing an inorganic pigment by using an ink containing an anionic anthraquinone dye is exposed to an oxidizing gas generated by creeping discharge or corona discharge. This shows that the method according to the present invention is excellent in decoloring property/color-reducing property. On the other hand, a residual optical density rate is high when a printed article according to any one of Comparative Examples 1 to 4 and 6 printed on a coated layer containing an inorganic pigment by using an ink free of any anionic anthraquinone dye is exposed to an oxidizing gas. In addition, a residual optical density rate is high in the case of the printed article according to Comparative Example 5 printed on a recording member not coated with any inorganic pigment by using an ink containing an anionic anthraquinone-based dye. Therefore, it can be found that a method according to any one of those comparative examples is poor in decoloring property/color-reducing property. Results similar to those described above were obtained when charging means was dielectric barrier discharge.

This application claims priority from Japanese Patent Application No. 2005-288842 filed on Sep. 30, 2005, which is hereby incorporated by reference herein.

What is claimed is:

1. A method of erasing an image comprising exposing an image, formed by applying ink containing a dye to a recording medium, to an oxidizing gas generated by discharge to erase the image, wherein the dye comprises an anionic anthraquinone dye.

2. A method of erasing an image according to claim 1, wherein the discharge is performed by at least one selected from the group consisting of creeping discharge, corona discharge, and dielectric barrier discharge.

3. A method of erasing an image according to claim 1, wherein the dye comprises Acid Blue 112.

4. A method of erasing an image according to claim 1, wherein the image comprises an image formed by ink-jet recording.

5. A method of recycling a recording medium comprising the step of erasing an image by the method of erasing an image according to claim 1.
